(19) United States
(12) Patent Application Publication
(10) Pub. No.: US 2024/0054320 A1
(43) Pub. Date: Feb. 15, 2024

(54) MULTI-DIMENSIONAL KNOWLEDGE GRAPH-BASED SYSTEM IN SUPPORT OF REGULATORY COMPLIANCE APPLICATIONS IN FINANCIAL SERVICES

(71) Applicant: Morgan Stanley Services Group Inc., New York, NY (US)

(72) Inventor: Eren Kurshan, New York, NY (US)

(21) Appl. No.: 17/819,122

(22) Filed: Aug. 11, 2022

(51) Int. Cl. G06N 3/042; G06Q 30/018; G06N 3/08

(52) U.S. Cl. CPC G06N 3/042; G06Q 30/018; G06N 3/08

(57) ABSTRACT

A method of providing a multi-dimensional knowledge graph including entities and relationships between entities comprises generating an initial entity component of the knowledge graph using underlying data including a plurality of entity nodes and one or more relationship edges that connect the entities, storing the entity component in computer memory, associating at least a first requirement with a one the relationship edges that defines an iterative or recursive functional description (“function”) of the relationship edge, wherein the function defines a dependency of the relationship upon conditions, parameters and other factors, each iteration or recursion of the requirement defining a dimension of the knowledge graph. The recursion proceeds until all conditions, parameters and other factors that determine a state of the relationships edge is included in the graph. The associated requirements included in the knowledge graph for the relationship edges are then store in computer memory.

### FIELD OF THE DISCLOSURE

The present disclosure relates to knowledge graphs, and more particular relates to methods for generating and using functionally and logically enhanced multi-dimensional knowledge graphs. In some implementations, the multi-dimensional knowledge graph is used to improve the effectiveness of regulatory compliance applications in financial services.

### BACKGROUND OF THE DISCLOSURES

A knowledge graph is a representation of a knowledge base using a graph-based structured data model or topology. It is commonly used to represent real-world entities such as places, events, objects and concepts as well as the relationships between them. In knowledge graphs, nodes typically represent entities and edges represent the relationships between these entities. Knowledge graphs can be effective in representing real-world data such as relationships between entities (such places, products, people, etc.). Knowledge graphs are useful because the data represented in the knowledge graph can be explored via structured queries. In addition, knowledge graphs can be used to interpret data and infer new facts. Knowledge graphs can also combine different types of data sources and relationships in siloed databases, providing the ability to represent complex relationships among different kinds of entities in real-world applications and incorporate hierarchies and semantics.

An example conventional knowledge graph is shown in FIG. 1A. In this simplified example, the knowledge graph 100 represents the publication and citation of a paper. The nodes (entity components) of the knowledge graph 100 are the author 102, the paper 104 (shown in two locations of the graph), a topic 106, a citation 108, and a publishing venue 110. The arrows between the nodes represent the relationships between the nodes. Two entities connected by a relationship constitutes and “entity segment.” In the depicted example, there is a relationship 112 pointing from the paper 104 to the author. Relationship 112 is denoted “written by” as the paper 104 is written by the author 102. Similarly, there is relationship 114 from the paper to the venue 110 denoted “published at.” Other relationships in the graph 100 include “contributed by” relations 116, 118, 120 between the topic 106 which are directed to the author 102, the paper 104, and the citation 108, respectively. There is also a “motivated by” relationship 122 between the topic 106 and the citation 108. Furthermore, there is a “citing” relationship 124 between the paper 104 and the citation 108, and a “cited by” relationship 126 between the same nodes in the reverse direction. There is also a “relevance” relationship 128 that is directed from the paper 102 to the topic 106. Even in the relatively simple example depicted in FIG. 1A, it can be seen that there are numerous relationships between the various nodes and various types of relationships.

A Knowledge Graph or heterogeneous network can be defined in abstract terms as:

G=(V,E)

in which G is the graph and each v is a vertex in V, and each e is an edge in E and where the entity types, characteristics and relationship types, characteristics between entities are defined through a schema.

In state-of-the-art knowledge graphs, edges in E are of Boolean type where the relationship is either true or false, i.e., they are Boolean relations. FIG. 1B illustrates such relationships between entities E1 and E2. In an example, E1 represents the composer Beethoven and E2 represents the Moonlight sonata, and the relationship (r1) is “composed by” which in this case is true. In the second case, Entity Ei may be the Lincoln Memorial, Ej the city of Chicago and the relationship (r2) is “located in”, which in this case is false.

However, in many subject areas, the relationships between entities are more complicated than Boolean relations. Such relationships can: (i) be conditional, in that they can be considered true or false only after consideration of additional factors; (ii) change on a temporal basis; and (iii) be dependent on other parameters. For example, in biological applications interactions of different proteins and enzymes are dependent on multiple conditions. Conventional knowledge graphs do not include or represent such complex relationships and thus their ability to provide useful information and solutions has shortcomings in many important applications. Similarly in financial applications, the compliance of actions and events are often determined by a complex list of conditions through numerous regulations imposed by regulatory entities.

There is accordingly a need to adequately represent such complex relationships in a knowledge graph data model or topology.

### SUMMARY OF THE DISCLOSURE

The present disclosure provides a computer-implemented method of providing a multi-dimensional knowledge graph that includes entities and relationships between entities, the method, executed by a processing unit of a computing system. The method comprises generating an initial entity component of the knowledge graph using underlying stored or streamed data, the entity component including a plurality of entity nodes and one or more relationship edges comprising connections between the entities, storing the entity component in a computer memory, associating at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds without human intervention until all conditions, parameters and other factors that determine a state of the particular one of the particular one or more relationships edges included in the graph, and storing all associated requirements included in the knowledge graph for the particular one of the one or more relationship edges in the computer memory

The plurality of entity nodes can comprise financial transactions, participants in the financial transactions, and information related to the financial transactions, and relationships between the financial transactions relate to compliance of the financial transactions with legal regulations. In such implementations, the connections from the one or more of the relationships define the conditions that determine whether the financial transactions are in compliance with legal regulations. The conditions that determine whether the financial transactions are in compliance with legal regulations can include one or more of: the time or date of the transaction, the location where the transaction takes place, and the citizenship and financial status of participants in the transaction.

In another aspect, the present disclosure provides a computer-implemented method of determining a status of a relationship in a multi-dimensional knowledge graph that includes entities and relationships between entities, the method, executed by a processing unit of a computing system. The method comprises generating an initial entity component of the knowledge graph using underlying stored or streamed data, the entity component including a plurality of entity nodes and one or more relationship edges comprising connections between the entities, storing the entity component in a computer memory, associating at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds without human intervention until all conditions, parameters and other factors that determine a state of the particular one of the particular one or more relationships edges included in the graph, storing all associated requirements included in the knowledge graph for the particular one of the one or more relationship edges in the computer memory, receiving a query to determine the status of the particular relationship in the knowledge graph, locating the particular relationship in the knowledge graph; and automatically determining the status of the relationship by ascertaining all of the requirements associated with the relationship and calculating all of the functions.

The present disclosure also describes a computing system for providing a multi-dimensional knowledge graph that includes entities and relationships between entities. The computing system comprises one or more processing unit, and one or more memory units configured to store storage knowledge graph components and underlying data; wherein the one or more processing units are configured to generate an initial entity component of the knowledge graph using underlying stored or streamed data, the entity component including a plurality of entity nodes and one or more relationship edges comprising connections between the entities. store the entity component in the one or more memory units, associate at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds without human intervention until all conditions, parameters and other factors that determine a state of the particular one of the particular one or more relationships edges included in the graph, and store all associated requirements included in the knowledge graph for the particular one of the one or more relationship edges in the computer memory. a computer-implemented method of determining whether a financial transaction, event, action or entity is in compliance with a regulation, performed using a multi-dimensional knowledge graph that includes entities and relationships between entities, the method, executed by a processing unit of a computing system. The method comprises generating an initial entity component of the knowledge graph using underlying stored or streamed data, the entity component including a plurality of entity nodes and one or more relationship edges comprising connections between the entities wherein the plurality of entity nodes include financial transactions, events, actions or participants, and relationships between the financial transactions relate to compliance of the financial transactions, event, actions or entities with regulations, storing the entity component in a computer memory, associating at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds until all conditions, parameters and other factors that determine a state of the particular one of the particular one or more relationships edges included in the graph, storing all associated requirements included in the knowledge graph for the particular one of the one or more relationship edges in the computer memory, querying the knowledge graph to ascertain the compliance status of a relationship present in the knowledge graph, and automatically determining the status of the relationship by ascertaining all of the connections and associated functions connected to the relationship and calculating all of the recursively defined functions.

In some embodiments, the one or more processors are further configured with a machine learning algorithm that receives as inputs knowledge graphs, historical and streamed data, and is trained learn the status of relationships between entities.

### BRIEF DESCRIPTION OF THE DRAWINGS

FIG. 1A is a conventional knowledge graph according to the prior art.

FIG. 1B shows conventional Boolean relationships used in knowledge graphs according to the prior art.

FIG. 2A illustrates two cases of complex non-Boolean relationships that can be represented in a knowledge graph according to the present disclosure.

FIG. 2B depicts a schema for illustrating complex relationships of a knowledge graph according to the present disclosure.

FIG. 2C is an illustration of another exemplary complex relationship in a similar schema as FIG. 2B.

FIG. 3A illustrates the embedding of entity information of the example shown in FIG. 2B.

FIG. 3B illustrates a complex relationship function that includes multiple hierarchical layers for automatically determining the status of exemplary relationship according to the present disclosure.

FIG. 4A illustrates an example relationship that is determined, in part, by use of a machine learning process.

FIG. 4B illustrates a knowledge graph that has three dimensions representing additional levels of functional dependence.

FIG. 5 is a block diagram of an example embodiment of a machine learning system that can be used to inform enhanced knowledge graphs according to the present disclosure.

FIG. 6 depicts an example enhanced knowledge graph according to the present disclosure having multiple hypergraphs that represent complex relationships.

FIG. 7 is an alternative depiction of the relationships shown in FIG. 6 in which a first plane showing the entities and their relationships is illustrated with a secondary layer including hypergraphs that define the functional relationships.

FIG. 8 shows the same knowledge graph as FIGS. 6 and 7 with an additional layer for depicting additional predeterminants and components.

FIG. 9 is a flow chart of an example embodiment of a method of determining the states of all relationships Rᵢⱼ that exist between entities Eᵢ through Eₙ in a knowledge graph according to the present disclosure.

FIG. 10 is a flow chart of an exemplary embodiment of a method for mapping “real-world” relationships onto a knowledge graph according to the present disclosure

FIG. 11 is a schematic block diagram of an example embodiment of a computer-implementable system that can be used to generate, modify and update enhanced knowledge graphs according to the present disclosure.

FIG. 12 is a block diagram of a computer system that can be used to execute a knowledge graph builder or alternatively, to access a knowledge graph by a user according to an embodiment of the present disclosure.

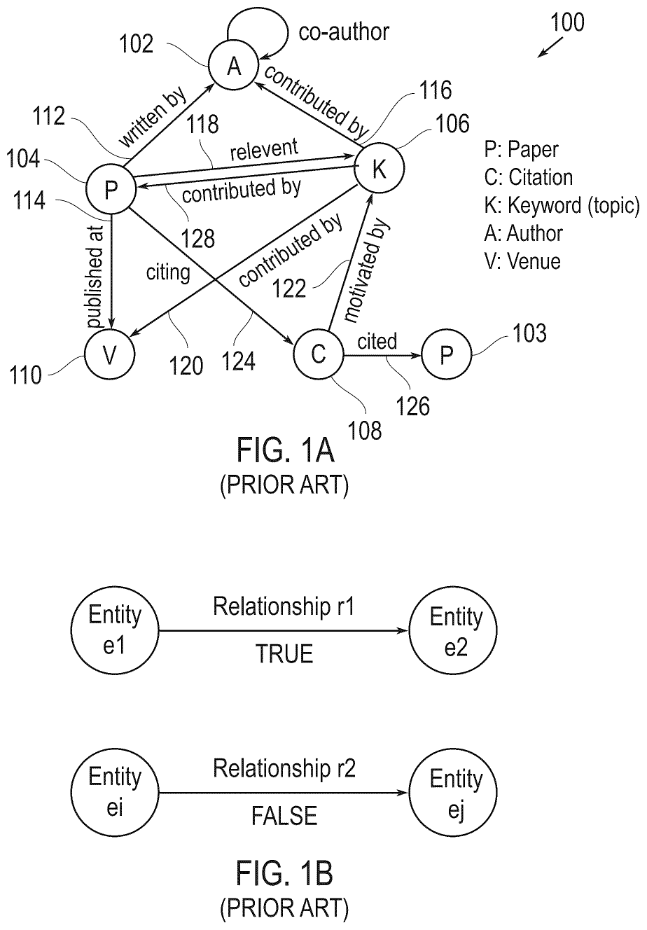

### DESCRIPTION OF CERTAIN EMBODIMENTS OF THE DISCLOSURE

The present disclosure describes methods, performed by a computing device or system, for generating and utilizing a knowledge graph in which complex relationships between entities are represented fully. The knowledge graph of the present disclosure comprises a multi-dimensional and recursive structure maintained in computer memory. The knowledge graph is enhanced as compared to conventional knowledge graphs in that the data structure is both hierarchically defined and recursive in its definition of relationships (edges), such that each relationship is represented as a function which can, in turn, be represented as a complex function and knowledge graph. Relationships in the knowledge graph structure of the present disclosure improve on conventional structures in that the relationships can include conditional relationships and can be characterized using multi-variate functions. The knowledge graphs with this expanded capability are termed “multi-dimensional” or “enhanced” knowledge graphs herein, and in certain embodiments can be rendered on a display of a computer to provide a visual representation of the levels of recursion being solved in any given function or part of the knowledge graph.

The proposed knowledge graph architecture aims to solve the complex relationships used in financial services applications such as regulatory and compliance functions, credit worthiness and risk functions. In financial services applications, many constructs are determined by the current financial regulations. As examples, the determination of whether an action or event is compliant according to the financial regulations, whether an action or event constitutes a financial crime, and whether a relationship with an entity constitutes a client relationship, etc. are often highly complex functions that generally cannot be simplified into Boolean, true/false answers.

However, regulations introduce numerous challenges when they are mapped on to the simple knowledge graph architectures with 0/1 connectivity between entities. Regulations may be local, state-level, federal, territorial, time/date dependent, conditional, etc. It is challenging to express such complexity through Boolean, yes/no, true/false, 0/1 connectivity in knowledge graphs. Due to these complexities, conventional knowledge graphs sometimes use “phantom nodes” to represent the conditions even though such nodes do not represent real entities but aim to solve the inability of the connection functions in representing real-world complexity. Similarly, due to the time dependency of the relationships impractical, frequent updates may be required to update the knowledge graph connections for each time point t, while it is nearly impossible to extrapolate other time points with such simple functional representations. Furthermore, frequent updates reduce the practicality of use of knowledge graphs.

Another example of the compliance functions of interest in financial services industry is sanctions. In sanctions, an individual, legal entity or country may be restricted based on certain regulations. Such regulations may be set by numerous regulators and law makers, may have complex conditions, location, time dependency and other complexities. None of these complexities can be expressed in a financial knowledge graph with Boolean connectivity between entities. The proposed architecture provides the underlying framework to represent the real-world complexities of such financial services functions.

The multi-dimensional knowledge graphs according to the present disclose solve this problem by introducing, according to one embodiment, a financial knowledge graph architecture that aims to represent the complex financial relationships such as regulatory compliance relationships, legality, etc. accurately with complex, multilayered functions. In this approach, relationships are: (1) functionally enhanced to represent the relationships in the knowledge graphs (as an example, a trading action may be compliant based on a number of logical conditions or mathematical functions that determine the connection function of the relationship); and (2) recursive representations of the complexity of the relationship functions through graphs, in which a relationship function can itself be defined in terms of a knowledge graph of conditional functions as well as other parameters, each of which may then be conditional functions and graphs themselves.

Through the full representation of the complexity of conditions for characterizing relationships, the proposed architecture can represent: (i) different regulatory compliance states for different locations, time periods, conditions, etc.; (ii) complex relationships between entities such as the definition of a client, which may depend on the local laws and regulations and may differ geographically; (iii) mathematical, conditional and time varying functions such as risk and compliance relationships; and (iv) controversial or undetermined states for events/actions or entities, where multiple outcomes may be possible depending on the input query.

The proposed knowledge graph-based architecture according to the present disclosure incorporates functional definitions for edges instead of fixed, Boolean definitions. The complex functions can have components of different characteristics including but not limited to: logical and rule-based relationships; multivariate functions; temporal functions; vector functions; discrete/continuous, deterministic/stochastic functional relationships; and combinations of one or more of the above. The logical-based relationships can be based on logical functions such as AND, OR, NOT, NAND, NOR, XOR, XNOR, etc., as well as conditional relationships such as if-then-else, and if-then-only-if. It is noted, however, that certain relationship functions can remain as Boolean variables as in conventional knowledge graphs and such relationships are not intended to be completely excluded.

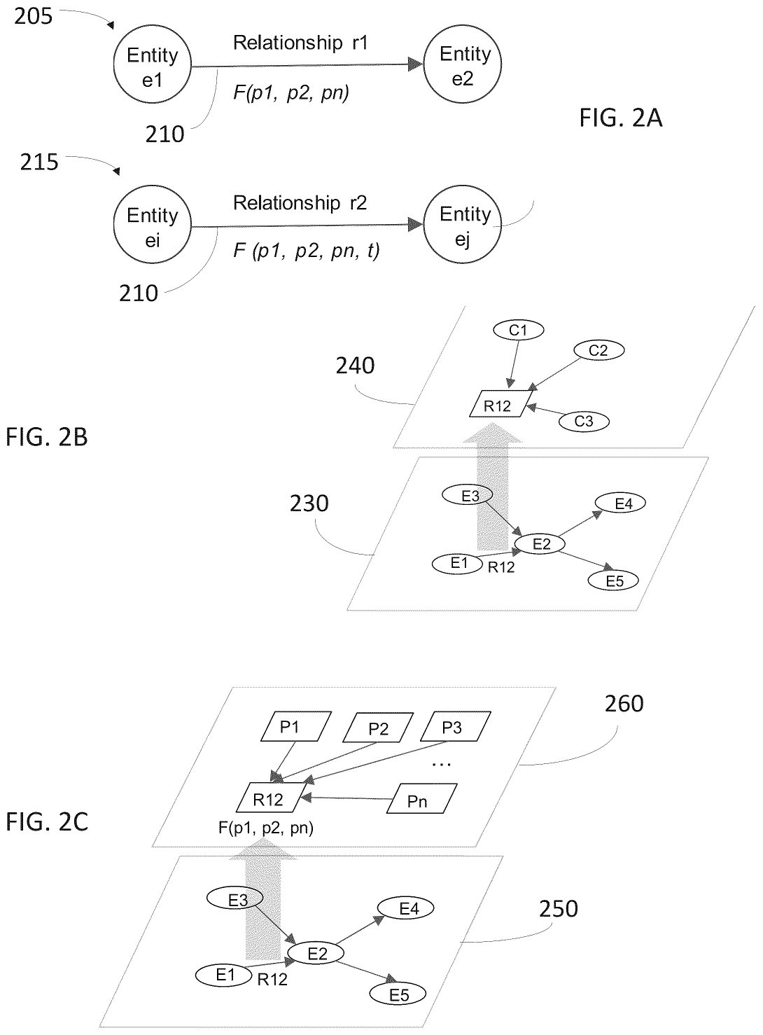

FIG. 2A provides an illustration of two cases of complex non-Boolean relationships that can be used in the multi-dimensional knowledge graphs according to the present disclosure. In the first case 205, there is a complex relationship 210 that points from entity E1 to entity E2. Relationship 210 is characterized as a function of a number of non-temporal parameters (n) labeled p1, p2 . . . pn. In the second case 215, there is a complex relationship 220 that points from entity Ei to Ej. Relationship 220 is characterized as a function of both non-temporal parameters p1, p2 . . . pn as well as time (t). Put another way, the relationships 210, 220 are associated with requirements that define an iterative or recursive functional description (also termed the “function”) of the relationship edge to which it is associated.

FIG. 2B depicts a schema for illustrating complex relationships of a knowledge graph according to the present disclosure. In FIG. 2B a first layer 230 (“entity component”) illustrates the entities E1-E5 and the relationships that connect the entities. One of these relationships R12 points between entities E1 and E2. An arrow points from the relationship R12 in entity component 230 to an orthogonal dimension or layer 240 (“secondary dimension”) of the knowledge graph which includes a further graph devoted to illustrating the complex relationship. In the second dimension 240, three circles labeled C1, C2 and C3 point to a parallelogram representing relationship R12. C1, C2 and C3 represent requirements or conditions upon which the value of R12 depends. For example, if there is an AND relationship between C1, C2 and C3, in order to determine the value of R12, it must first be determined that all of C1, C2 and C3 are true. In a financial services context, C1-C3 can represent compliance conditions that must be met for a particular transaction to obtain approval. Since the knowledge graph as a whole contains both the information of entity component 230 and the secondary dimension 240, the knowledge graph can be considered to be a multidimensional framework. The secondary dimension 240 is linked to the entity 230, or equivalently, the entity component 230 “points to” the secondary dimension 240 of the knowledge graph in that the information in the secondary dimension 240 describes the relationships in the entity component 230. It is noted that the term “dimension” is used metaphorically. While in FIG. 2B the entity component 230 and the secondary dimension are depicted as distinct planes separated vertically, this is for illustrative purposes and the data represented by the distinct dimensions can be illustrated differently. The main notion is that additional dimensions (i+1) can branch off from the relationship edges of dimension (i) to include and describe, in dimension (i+1), the functional dependence of relationships within dimension (i).

It will be appreciated that while one relationship R12 has been depicted in secondary dimension 240, other relationships between the entities (that are not depicted for ease of illustration) could also be rendered in the knowledge graph. The graphs of each relationship within the secondary or additional dimensions are referred to as “hypergraphs” herein.

Moreover, the depictions of the knowledge graphs herein are intended for an understanding of the data structure construct, while persons having ordinary skill will appreciate that the data structure is implemented, inspected, updated, and so on by code executing within the memory of a computer. As discussed further below, the data structure of the knowledge graph can be implemented in various ways depending on the supporting computing platform. For example, the data structure can be implemented differently when using a Turing machine, field programmable gate array (FPGAs), or a graphic processing unit (CPU).

FIG. 2C is an illustration of another exemplary complex relationship in a similar schema as FIG. 2B. The entity component 250 shows entities E1-E5 and their respective relationships. A secondary (orthogonal) dimension 260 illustrates a different case for relationship R12 between E1 and E2. In the case shown in secondary dimension 260, parallelograms labeled P1, P2, P3 . . . PN can represent parameters having a value, such as a number or alphanumeric string. The value of R12 depends on the values of the all of parameters P1-PN. Using the context of financial services compliance as an example, the relationship R12 may be the compliance of an “insider trade” (i.e., a trade in the shares of a company by a someone affiliated with the same company) by a board member of the company and the conditions required for the trade to be allowed. These conditions may be, for example, geographically determined, territorial, time dependent, etc. Outside of the field of compliance, the relationship R12 may be “know your client” (KYC) requirements for a customer to be onboarded as a client to a financial institution, in which different confirmations (“checks”) and requirements are ascertained in order for the relationship function to be calculated. In another implementation, the relationship R12 can be an “accessible by” relationship that allows an entity (E1) such as a company access to a credit line (E2) and a subset of P1-PN can represent monetary values indicating the credit worthiness of E1. Other values of P1-PN can represent other status variables required for E1 to be able to access the credit line of E2.

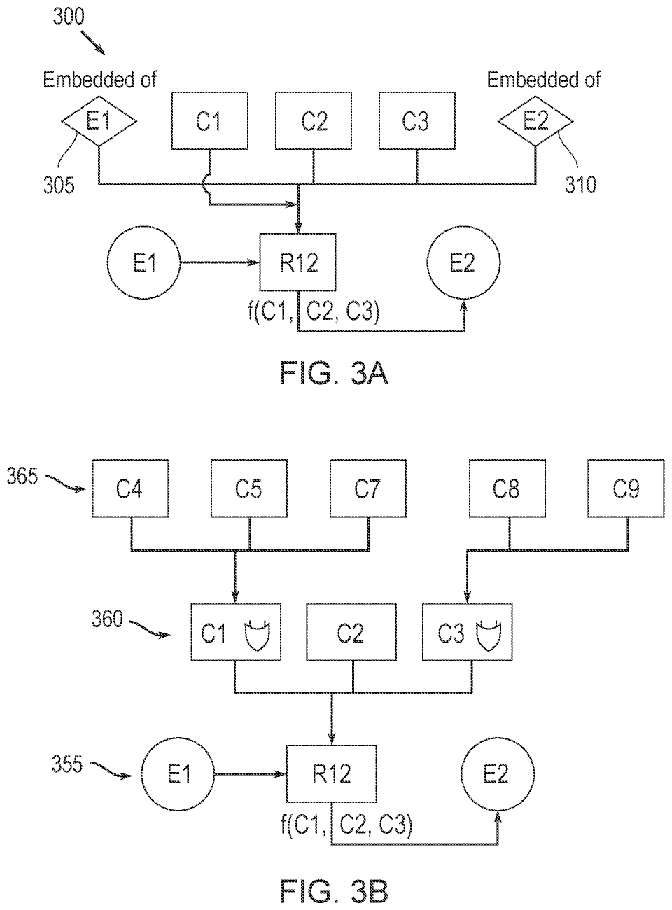

As can be discerned from FIGS. 2B and 2C, the proposed knowledge graph-based architecture can be considered as a hierarchical/recursive structure in which the individual edges can each be associated with their own knowledge graphs of requirements (e.g., conditions, parameters and other factors which can include special parameters such as functions, data that fluctuates and has an applicable value at the current point in time that the graph is being interrogated, or stored data which does not vary). It is noted however, that the entities themselves may be associated with one or more values that enter into the determination of the status of the relationship with which they are associated. FIG. 3A shows the conditional relationship shown in FIG. 2A in which conditions C1-C3 enter into the determination of the relationship R12. FIG. 3A shows in addition the “embedding” 305 of E1, which represents data associated with entity E1, and the embedding 310 of E2, which represents data associated with entity E2. An embedding in this context may be a learned vector representation of one of the entities. As shown, the embeddings 305, 310 of E1 and E2 together with the conditions C1, C2 and C3 point to the relationship R12, indicating that they all contribute to the determination of the status of R12. Moreover, relationship R12 is determined as a function of C1-C3 and embeddings 305, 310 f(C1, C2, C3, E1, E2). In this manner a full determination of the status of relationship R12 involves a traversal of embedding, conditions and functions that can encompass numerous scenarios. This approach enables a wide spectrum of relationships to be represented in a knowledge graph with potentially complex conditional and functional calculations.

FIG. 3B illustrates a more complex relationship function that itself includes multiple hierarchical layers for automatically determining the status of exemplary relationship R12 using one or more suitably programmed processors. As shown, the first two layers of the relationship are the same as shown in FIG. 3A, namely, there is a directed relationship R12 pointing entity E1 to E2 in the first layer 355. In a second layer 360, conditions C1, C2 and C3 point to relationship R12, indicating that the status (value) of the relationship depends upon the prior determination of the status of the conditions C1, C2, C3. In a further third layer 365, it can be seen that the conditions C1 and C3 depend, in turn, upon additional conditions. In the depicted example, C1 depends upon conditions C4, C5 and C7, and condition C3 depends upon conditions C8 and C9. The OR-gate symbol shown on condition C1 indicates that conditions C4, C5 and C7 are linked to condition C1 via an OR relationship, meaning that C1 will be true if any of C4, C5 and C7 are true. Likewise, the OR-gate symbol shown on condition C3 indicates that conditions C8 and C9 are linked to C3 via on OR relationship, meaning that C3 will be true if either C8 or C9 are true. Numerous other logical and other relationships between the various conditions are also possible.

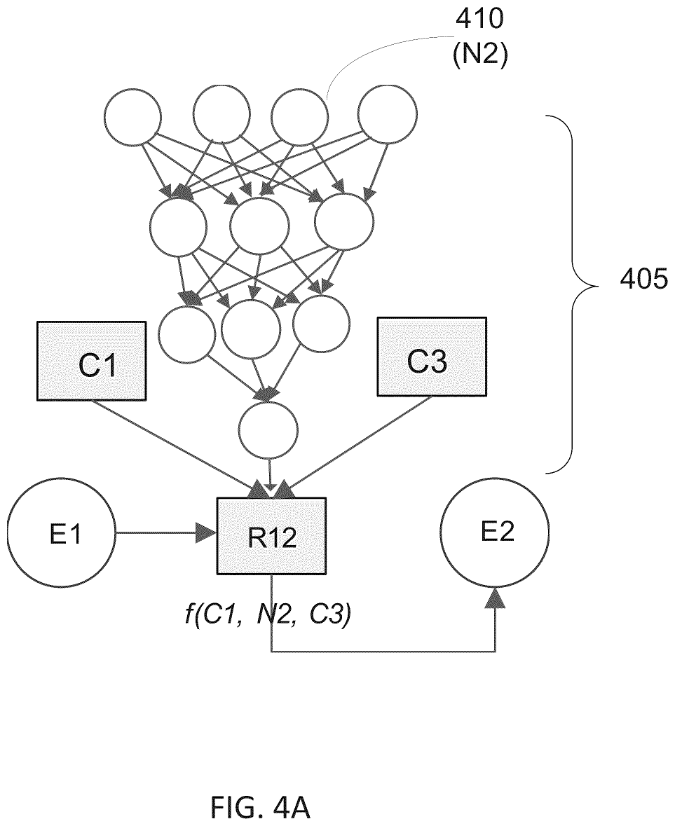

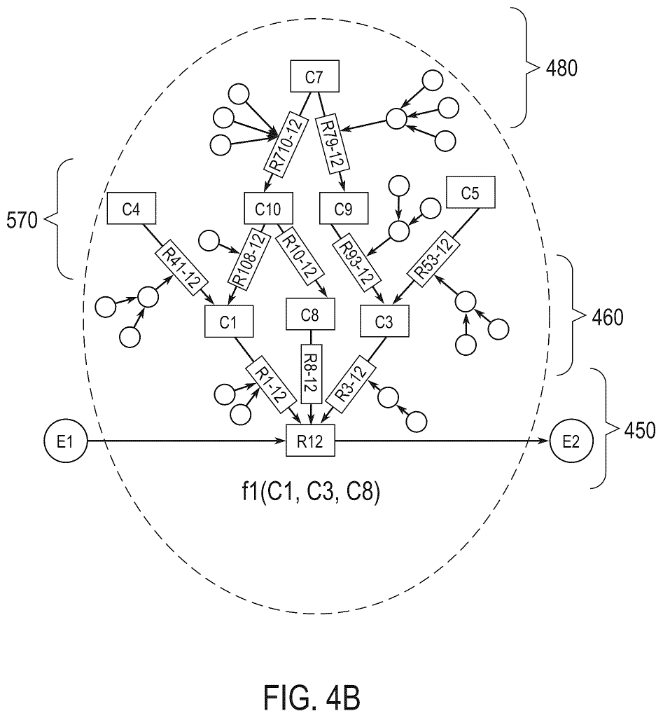

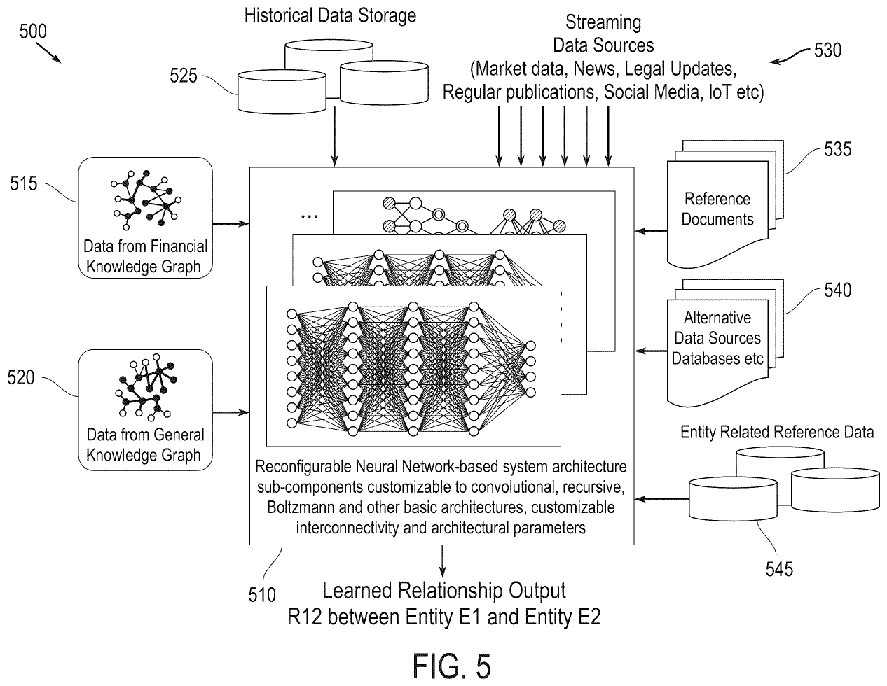

FIG. 4A illustrates an example relationship R12 that is determined, in part, by use of a machine learning process. As shown, 405 includes condition C1 and condition C2 that point to and inform relationship R12. In addition, a machine learning system 410 points to R12, indicating that the status of relationship R12 depends in part upon the execution and output of the machine learning system 405. In this embodiment, the connectivity between entities E1, E2 is learned over time based on data inputs to the machine learning system 405. There are numerous ways in which a machine learning network algorithm can be implemented in this context. One embodiment of a machine learning system that can be used to inform the multi-dimensional knowledge graphs is shown in FIG. 5.

In the example embodiment shown in FIG. 5, a machine learning platform 500 is geared toward a financial services application. At the center of machine learning platform 500 is a reconfigurable neural network-based system 510 (“machine learning network”) that can include any number of algorithmic sub-components including but not limited to convolutional, recurrent, Boltzmann, multi-level perceptron and other machine learning algorithms, together with adaptive connectivity and parameters that can be reconfigured based on performance or other factors. The various machine learning algorithms employed can be supervised, semi-supervised or unsupervised. One set of data inputs to the machine learning network 510 includes data from one or more financial knowledge graphs 515 and data from one or more general knowledge graphs 520. Another set of data inputs includes stored historical data 525 and streamed data 530. The streamed data 530 can include market data, current news, informational updates, etc. Further sources of data input to the machine learning network 510 include reference documents 535, alternative data sources/databases 540 and entity-related reference data 545. In the case of supervised machine learning algorithms, the machine learning network 510 learns from the correlation between input data groups 525, 530, 535, 540, 545 and already-completed knowledge graphs 515, 520 how the various relationships among the input data can condition the status of relationships between the entities. In this manner, when a new knowledge graph is generated, and a relationship between entities is determined based on new or updated input data. Machine learning networks can be employed instead of a predefined condition or parameter to determine, at least in part, the state or value of a relationship.

FIG. 4B illustrates a knowledge graph that has three layers representing additional levels of functional dependence. In an entity component 450, a relationship R12 between entities E1, E2 is shown. In a secondary orthogonal dimension 460 that connects to the entity component, conditions C1, C3, C8 point to relationship R12, indicating that R12 depends upon the status of conditions C1, C3, C8. Condition C1 is linked to relationship R12 via secondary relationship R1-12. Two red circles pointing relationship R1-12 indicate additional parameters that factor into the determination of secondary relationship R1-12. Condition C8 is linked to relationship R12 via secondary relationship R8-12 while condition C3 is linked to relationship R12 via secondary relationship R3-12. A sequence of red circles pointing to C3 indicate a sequence of parameters that factor into the determination of secondary relationship R3-12, in which one of the parameters depends on the status or value of a further parameter. The status/value of conditions C1, C3, C8 are in turn determined by further conditions in a further orthogonal “tertiary” dimension 470. Condition C1 depends on conditions C4 and C10 via tertiary relationships R41-12 and R101-12. Condition C8 depends on condition C10 via tertiary relationship R108-12 and condition C3 depends upon conditions C9 and C5 via tertiary relationships C93-12 and C53-12. Several of the tertiary relationships are linked to red circles indicating their further dependence on various parameters. Lastly, conditions C10 and C9 are determined by yet another layer of conditions represented in further orthogonal “quaternary” dimension 480. Condition C7 of quaternary dimension 480 is linked to condition C10 via quaternary relationship R710-12 and to condition C9 via quaternary relationship R79-12. Red circles pointing to quaternary relationships R710-12, R79-12 indicate the functional dependence of the status of the relationships on additional parameters that have their own dependencies. FIG. 4B provides some indication of the levels of complexity that can be depicted using the multi-dimensional knowledge graphs of the present disclosure.

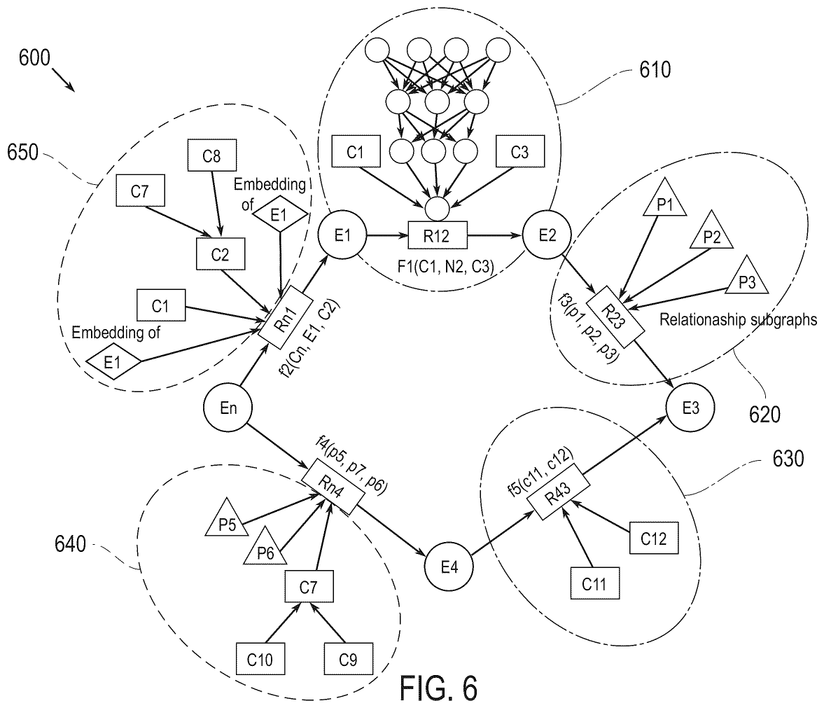

The figures described thus far mostly pertain to functions that define a single entity-to-entity relationship. FIG. 6 depicts an example knowledge graph 600 according to the present disclosure with multiple hypergraphs that represent complex entity-to-entity relationships. FIG. entities, E1, E2, E3, E4 and En. A relationship R12 points from E1 to E2, relationship R23 points from E2 to E3. Relationship R43 points from Entity E4 to E3. Thus, in the depicted example, two relationships R23 and R43 are directed to E3. Relationship RN4 points from entity Eₙ to E4, and relationship RN1 points from entity Eₙ to E1. In this manner, two relationships RN4, RN1 are “directed from” En. Each relationship is associated with a hypergraph. Each hypergraph can be considered to exist in a secondary or further orthogonal dimension.

In knowledge graph 600, relationship R12 is associated with hypergraph 610, relationship R23 is associated with hypergraph 620, relationship R43 is associated with hypergraph 630, relationship RN4 is associated with hypergraph 640 and relationship RN1 is associated with hypergraph 650. Hypergraph 610 is the same as the hypergraph shown in FIG. 4 and includes required conditions C1, C2 and machine learning network N2 that point to and determine relationship R12, which is a function of C1, C2 and N2. Hypergraph 620 includes three parameters p1, p2, p3 which point to and determine relationship R23, which is a function of p1, p2 and p3. Hypergraph 630 includes conditions C11 and C12 which point to and determine relationship R43, which is therefore a function of C11 and C12. The hypergraph 640 for relationship RN4 includes, at a first layer, parameters p4, p5 and condition C7. p4, p5 and C7 directly determine relationship RN4. At a second layer, hypergraph 740 includes two additional conditions C9, C10 which, in turn, determine the status (value) of condition C7. Hypergraph 650 for relationship RN1 includes, at a first layer, the embeddings of entities E1 and Eₙ and condition C1 and C2. Collectively, E1, En, C1 and C2 directly determine the status of relationship RN1. C2 depends, in turn, on conditions C7 and C8, which is reflected in the second layer of hypergraph 650.

It is noted that hypergraphs 610 and 650 share conditions C1 and C2 and hypergraphs share condition C7. This is intended as the same conditions can be applied to determine various relationships in different hypergraphs.

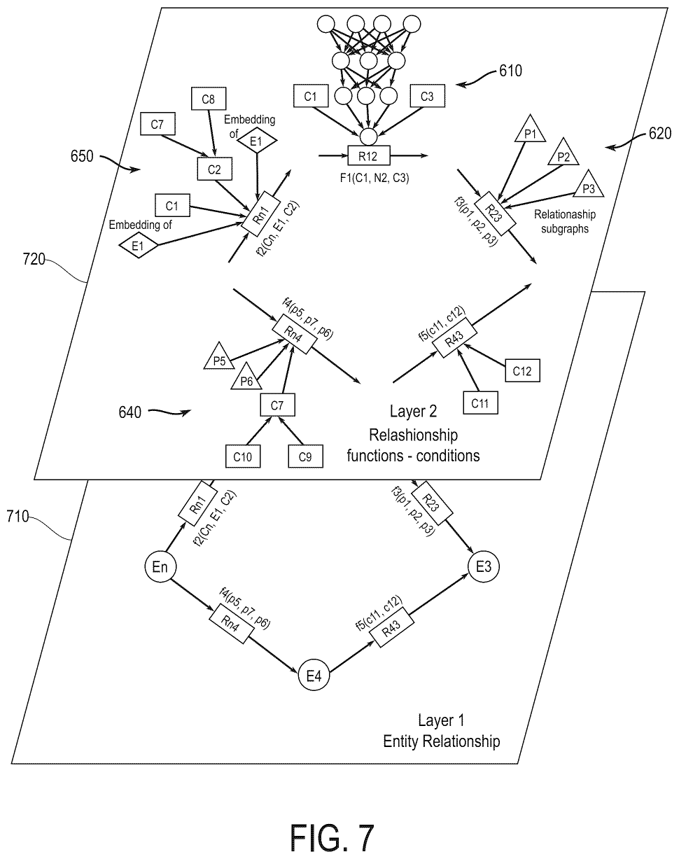

The knowledge graph shown in FIG. 6 is illustrated in an alternative manner in FIG. 7, wherein entity component 710 shows the entities and their functional relationships and secondary dimension 720 includes hypergraphs that contain requirements associated with and defining the functional relationships. For this instance, he knowledge graph of FIG. 7 can therefore be considered to be a three-dimensional (3D) knowledge graph in which the secondary dimension is orthogonal to the entity component. Since components can be dependent on further conditions and parameters in further layers (as shown, for example, in FIG. 4B), the multi-dimensional knowledge graphs can be defined in n-dimensions, in which n is any positive whole number. To be clear, the graphical representation of the knowledge graph is for purposes of illustration while the reader should appreciate and understand that all implementations of the multi-dimensional knowledge graphs according to this disclosure are within the memory of a computer and the hierarchical and functional relationships are encoded into the data structure that defines the multi-dimensional knowledge graph.

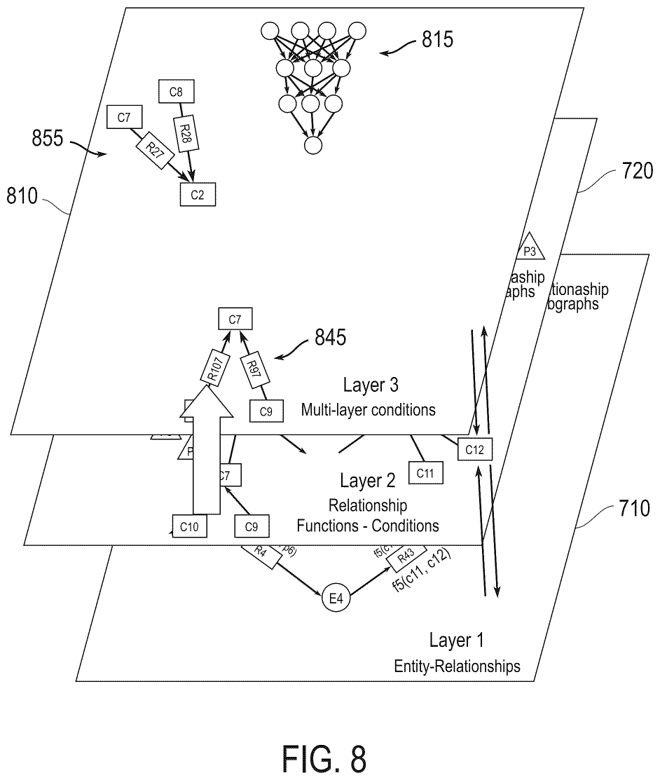

FIG. 8 shows the same knowledge graph as FIGS. 6 and 7, but in this case an additional tertiary dimension 810 is used to show the predeterminants and components of the functional relationships shown in secondary dimension 720, where such predeterminants and components are present. In the example depicted, FIG. 8 shows the second layer 815 of hypergraph 610, which includes the additional layers of the machine learning network N1, within tertiary dimension. 810. Similarly, FIG. 8 shows the second layer 845 of hypergraph 640 which depicts the dependence of condition C7 upon conditions C9 and C10, within tertiary dimension 810. In this second layer hypergraph 845, it is noted that the dependence of C7 upon C9 is characterized by an additional relationship R97, and the dependent of C7 upon C10 is characterized by another relationship R107. The intra-relationships between conditions, functions and parameters, such as R97 and R107 can be of the same or different types than the relationships between entities. FIG. 8 also shows the second layer 855 of hypergraph 650 which depicts the dependence of condition C2 upon conditions C7 and C8. The dependence of C2 upon C7 is characterized by an additional relationship R27, and the dependent of C2 upon C8 is characterized by another relationship R28.

It is noted that when the knowledge graph 600 is accessed, information and queries flow “upwardly” and “downwardly” between within the n-dimensions of the knowledge graph. A configured algorithm proceeds by traversing upwardly to calculate the status of the functions, conditions, parameters, etc. that determine the status of the relationships, and then downwardly, to bring the results of the calculations toward a conclusion of the status of the relationship within the foundational entity component. The information flow is illustrated by the arrows which traverse between entity component 710 and secondary orthogonal dimension 720 and between the secondary and tertiary orthogonal dimensions, 720 and 810.

As an example, in order to determine the relationship between RN4 between entities Eₙ and E4 which is on entity component 710, the hypergraph 640 of the second orthogonal dimension 720 is traversed. However, to determine the value of condition C7 in hypergraph 640, the second-layer hypergraph 845 of tertiary orthogonal dimension 810 is traversed. The flow for fully traversing the complexity of the relationship RN4 is thus upwards from entity component 710 to secondary dimension 720 and then to tertiary dimension 810. However, upon traversal of hypergraph 845, the traversal ends as there are no further dimensions to traverse. At this point conditions C9 and C10 are determined in order to assess the status of condition C7. Once the status of C7 is determined, the information flows downward from tertiary dimension 810 to secondary dimension 720 in which the status of condition C7 is used in the determination of the status of relationship RN4. In turn, once the status of relationship RN4 is determined in secondary dimension 720, the results flow down to entity plane 710 in which the determined status of the relationship between entities RN and R4 is shown.

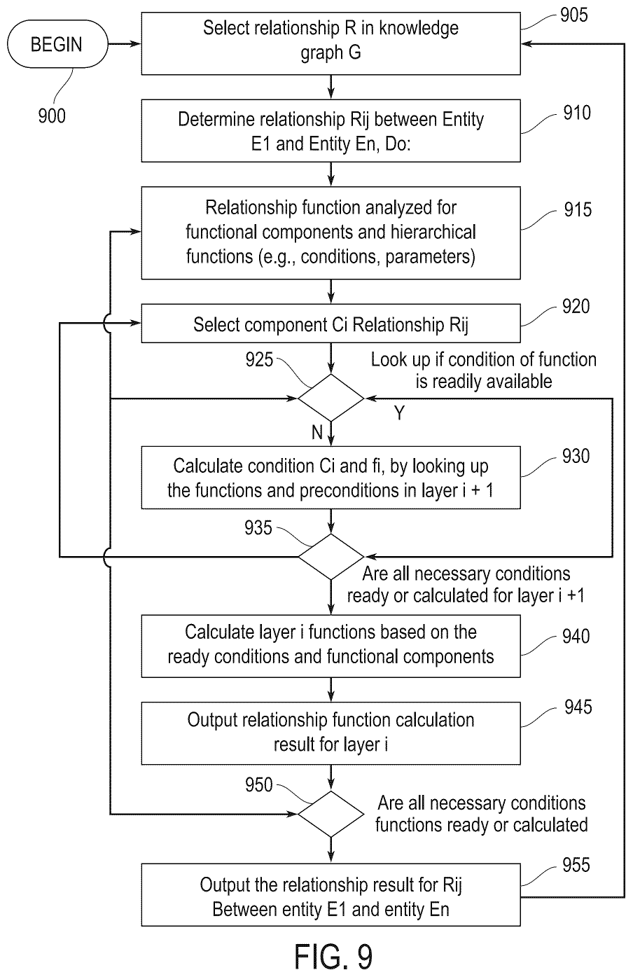

FIG. 9 is a flow chart for an example embodiment of a method of determining the states of all relationships Rᵢⱼ that exist between entities Eᵢ through Eₙ in a knowledge graph according to the present disclosure. The method begins in step 900. In step 905, a particular relationship Rᵢⱼ of the knowledge graph is selected. Step 910 begins the process of determining the state of the selected relationship Rᵢⱼ. In step 915, the relationship function (f) of relationship Rᵢⱼ is analyzed for components and further hierarchical functions. In one implementation, this analysis is performed recursively. Once the relationship function has been analyzed, in the following step 920, a component Cᵢ is selected and in step 925, it is determined whether the status of the condition Cᵢ is readily available for calculation. If it is determined in step 925 that component Cᵢ is not readily available (based on information in the current dimension), in step 930 the next dimension i+1 is traversed 930 to determine the status of conditions and functions in dimension i+1. If it is determined in step 925 that component Cᵢ is readily available based on information in the current dimension (i), then the process flows to step 935 in which it is determined whether all conditions ready or calculated for dimension i+1. If in step 935, it is determined that all conditions are ready or calculated for dimension i+1, then in step 940 the process moves from i+1 to 1 and all dimension i functions are determined based on the ready conditions and functional components.

If, on the contrary, it is determined in step 935 that not all conditions are ready or calculated for dimension i+1, then the process cycles back to step 920. After step 940, in the following step 945, the relationship function for dimension i is output. In step 950 it is determined whether all necessary conditions, parameters and functions for determining the state of relationship Rᵢⱼ are ready or have been calculated. If so, in step 955, the state of the relationship Rᵢⱼ between entities Eᵢ and Eₙ is output. After step 955, the process cycles back to step 905 for selection of another relationship of the knowledge graph. If it is determined in step 950 that all necessary conditions, parameters and functions for determining the state relationship Rᵢⱼ are not ready or have not been calculated, the process cycles back to step 915 for further analysis of the relationship function followed by selection of another condition.

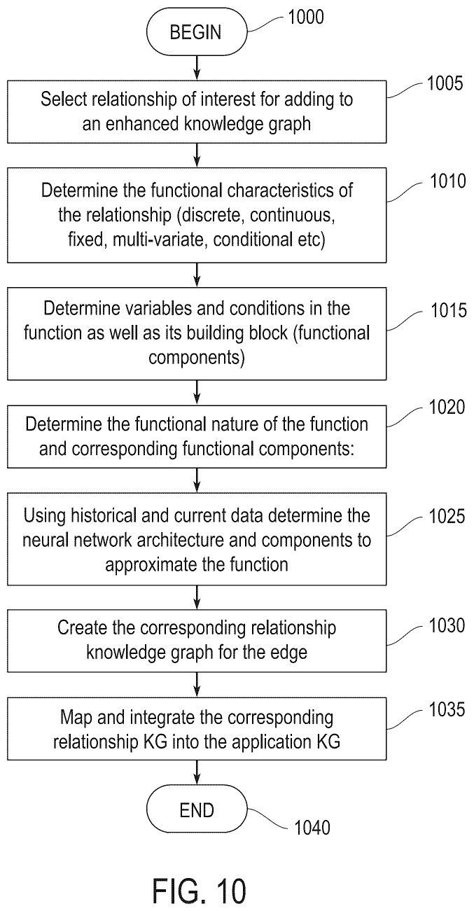

FIG. 10 is a flow chart of an exemplary embodiment of a method for mapping “real-world” relationships onto a knowledge graph according to the present disclosure. The method begins in step 1000. In step 1005 a relationship of interest (e.g., edge of an existing knowledge graph) to be added to the multi-dimensional, recursive (or fractal-like) knowledge graph. In step 1010, the functional characteristics of the relationship, including but not limited to whether it is discrete or continuous, fixed, conditional, or multi-variate, are determined. In the following step 1015, the variable and conditions (functional components) including any embedded elements of the relationship function are determined. In step 1020, the nature of the function and its components are determined (e.g., it is determined whether it is time dependent, discrete, continuous, deterministic, non-deterministic, fixed, learned etc.) In the following step 1025, the function is approximated by a neural network architecture and components using historical and current data. After approximating the function, in step 1030, the corresponding hypergraph is created for the relationship. In step 1035, The hypergraph is integrated into the knowledge graph. The method ends in step 1040.

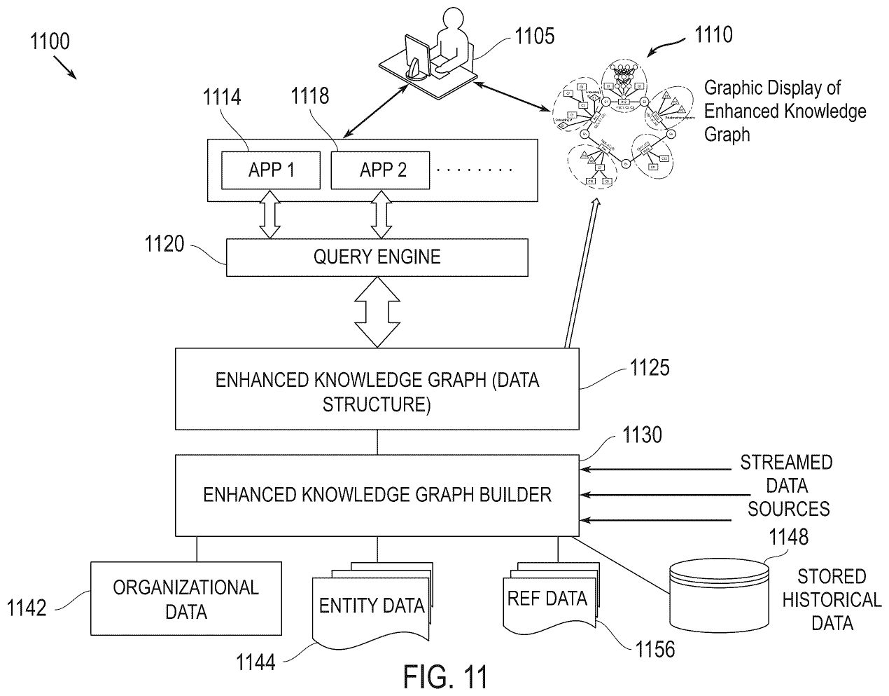

FIG. 11 shows an example embodiment of a computer-implementable system 1100 that can be used to generate, modify and update enhanced knowledge graphs according to the present disclosure. Describing the system from the top down, a user 1105, for instance an employee of an organization, interacts with the system 1100 in order to, for example, obtain information from a knowledge graph, add information to a knowledge graph data structure, or view information in the form of a graphically-displayed enhanced knowledge graph 1110. The multi-dimensional knowledge graph 1110 within the memory of the computer can be displayed in one or more of the ways described above with reference to FIGS. 4A-8, for example, with clearly illustrated vertically-separated dimensions, or in a more flattened presentation. In some embodiments the user interacts directly with various applications, e.g., APP 1 1114, APP 2 1118, etc. Applications APP 1 1114, APP 2 1118 can be database applications or other types of software applications. Through APP 1, APP 2, the user 1105 can request information regarding entities and relationships in the organization which is transferred to a query engine 1120. The query engine 1120 processes the requests from the applications and converts the request into a format that can be used to search a knowledge graph data structure 1125. The query engine 1120 operatively connects to the multi-dimensional knowledge graph data structure 1125 using application program interfaces (API) as known in the art. The multi-dimensional knowledge graph data structure 125 incorporates all of the entities, relationships, functional components (conditions, parameters), and links to other sources of information such as the machine learning network of which an example is shown in FIG. 5. This data structure can comprise alphanumeric data linked by various pointers to other data, function and procedure calls, etc. that incorporates the full complexity of a multi-dimensional enhanced knowledge graph. The multi-dimensional knowledge graph data structure 1125 is not a graphic representation of the data, but rather it is a representation of the data that is stored in computer memory.

The multi-dimensional knowledge graph data structure 1125 is generated and maintained by a knowledge graph builder module 1130 (“knowledge graph builder”). The multi-dimensional knowledge graph builder 1130 is provided access to numerous sources of information and is configured to incorporate the information into the multi-dimensional knowledge graph data structure 1125. The information accessible by the multi-dimensional knowledge graph builder. The knowledge graph builder 1130 is configured with recursive extraction logic that enables it to recursively derive functional dependencies in the data it receives. For example, from the data that the multi-dimensional knowledge builder assembles it can, in addition to linking entities by relationships, determine conditions that affect and determine the states of the relationships. Sources of data to which the multi-dimensional knowledge graph builder is operatively connected or otherwise provisioned with include, but are not limited to, organizational data 1142, entity-related reference data 1144, stored historical data 1148, current data streams 1152, various additional forms of reference data stored in databases (internal or external) or documents 1156, and previously-generated knowledge graphs 1160. In a financial services context, the multi-dimensional knowledge graph builder 1130 can be communicatively connected to organization backend systems including trading, accounting, compliance, customer relationship management (CRM), and legally-accessible human resource systems, among other possible sources.

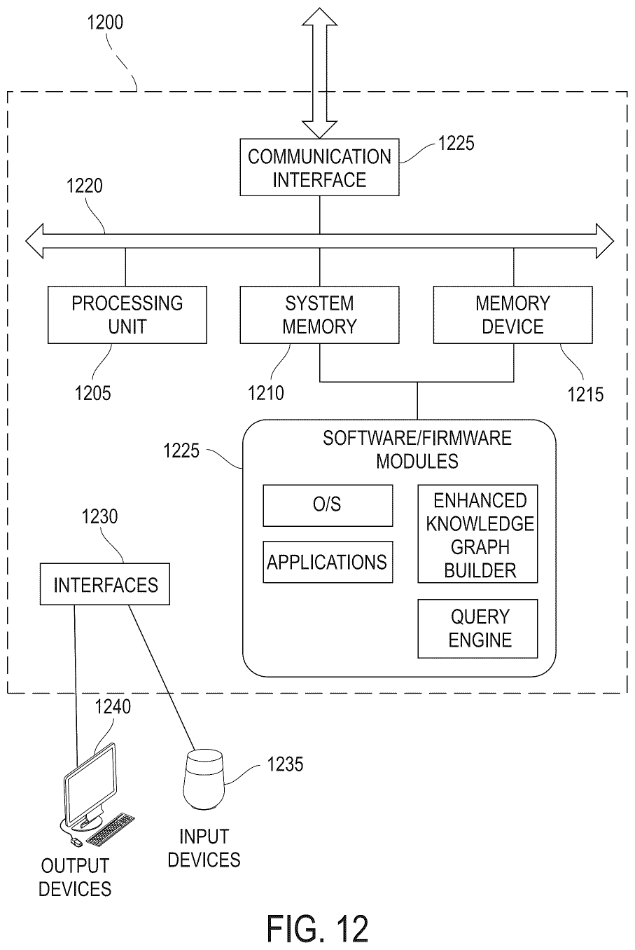

The computer-implementable system described in FIG. 11 can be implemented using any computing system have requisite processing and memory resources and connectivity. The system 1100 can be implemented in a private network in an organization or in the “cloud” using a software-as-a-service (SaaS) or platform-as-a-service (PaaS) model. An example of a computer system that can be used to execute a knowledge graph builder or alternatively, to access a knowledge graph by a user, is shown in FIG. 12. The computer system 1200 includes a hardware processing unit 1205, a system memory 1210, and memory device 1215 connected to a system bus 1220. A communication interface device 1225 is also connected to the system bus 1220. The processing unit 1205 can comprise one or more computational units such as CPUs, GPUs, TPUs, neuromorphic chips, etc. The system memory 1210 may include read-only memory (ROM) and random access memory (RAM). The internal data storage device 1215 may be an internal hard disk drive, flash memory, optical disk drives, zip drives and/or other devices. The system memory 1210 and memory devices 1215 store knowledge graph components in triples or other forms, other types of storage and data systems to store schema and graph-level information. The system memory 1210 can access a number of program modules 1225 including, for the purposes at hand, an operating system, applications programs (e.g., APP1, APP2 discussed above), the multi-dimensional knowledge graph builder and query engine. The program modules can be called into system memory from the instructions issued from the processing unit 1205 and then executed by the processing unit. The processing unit is configured to perform the methods of building enhanced knowledge graphs and determining the complex relationships therein discussed above. The computing system 1200 also includes an interface 1230 that enables the input of data from input devices 1235 such as a keyboard, touch pad, mouse, microphone, etc. and the output of data, including a displayed enhanced knowledge graph via output devices 1245 such as LCD displays, speakers, etc. In certain implementations, multiple processing units 1205 are used in parallel to implement the functionality of the various program modules described herein.

The computer system 1200 preferably operates in a networked environment using logical connections to one or more wired and/or wireless communication networks via communication interface 1225. The communication networks can be local area networks (LAN) and/or larger networks, such as a wide area network (WAN) or the Internet. The communication interface 213 may provide access to organizational backend systems, external databases, streaming sources and so on.

In addition, the computer system includes or has access to (via the communication interface) machine learning components that are configured to learn relationships between entities over time based on historical or streaming data and other conditions, parameters and factors. The machine learning components can include neural network elements to implement part of the learning capabilities. These can be executed by hardware specifically adapted for machine learning tasks such as TPUs (tensor processing units), neuromorphic chips or other dedicated hardware. However, machine learning components can also be implemented using more standard CPU hardware.

The multi-dimensional knowledge graph described herein provides an enhanced, specific type of data processing system designed to improve the way processes financial information to account for the complexity of relationships between various entities. Both efficiency and accuracy are thereby improved by the data structure comprising the use of a multi-dimensional knowledge graph as described herein. The proposed architecture provides a significantly better approximation in representing complex relationships between entities in the real world. It enables time dependence and reconfigurability as well as learning functions to represent the flexibility in real-world relationships.

There are numerous direct applications for the multi-dimensional knowledge graphs described by the present disclosure, a few of which are described as follows. In the financial and legal services fields, there are many instances in which the determination of whether an event, action or transaction is compliant or legal is necessary. In a conventional knowledge graph, this event/action/transaction (hereinafter termed “action” for brevity) would be represented in a binary fashion as Yes/No or True/False. However, in reality the legal/compliance status of the action can depend upon a number of conditions and factors, including but not limited to: the time or date of the action (e.g., whether certain regulations are in force at the time/date); the location where the action takes place, which governs which law and regulations are applicable; the parties and entities involved; various conditions and exemptions that may be based on citizenship, and numerical parameters of the transaction. The multi-dimensional knowledge graphs of the present disclosure tackle the deficiency of conventional knowledge graphs in capturing this complexity by incorporating complex functions to represent the relationships involved. As noted above, these functions can include complex/conditional or logical functions, learned relationships, dynamic, time dependent relationships, probabilistic relationships, multiple functions or functional variants, and even contradictory, unresolved or contested factors or relationships.

Another example involves general purpose knowledge graphs and reasoning tasks. Scientific results typically have disclaimers that make them dependent upon the most recent research and experimental results. If general scientific knowledge is set in an enhanced knowledge graph framework according to the present disclosure, new findings can be incorporated in such a way as to fully update the state of knowledge represented by the graph because complex relationships are accounted for within the graph. For instance, the questions whether new financial crime patterns are emerging may depend upon analysis or machine learning based on underlying data. An illustration of this phenomenon outside of the financial services domain is the question as to whether a Covid Vaccine is effective. The answer to this will change over time as larger data samples are collected and different viral variants emerge. All of this information can be incorporated into enhanced knowledge graphs that can be continually updated over time.

Enhanced knowledge graphs according to the present disclosure can also be usefully applied to detection of financial crimes such as money laundering and fraud. As financial crime detection systems are governed by law and regulations, changes in such laws and regulations can change the status of a transaction from normal to criminal or vice versa. As an example, a director of a corporation trading the company stock may be illegal without meeting declaration requirements and other conditions.

As discussed earlier, another embodiment is the sanctions screening. Whether an individual, legal entity or territory/country is permitted to perform financial transactions may be a highly complex function determined by a number of regulations which are time dependent. The proposed system captures this complexity by appropriately representing the underlying functions.

Conventional knowledge graph systems that cover this area would need to be taken offline and updated to reflect such changes to the regulations, with attendant challenges in terms of operations and record keeping. The multi-dimensional knowledge graph solves this problem by incorporating functions that can be automatically updated.

Organizational “know-your-client” (KYC) programs provide another useful application of enhanced knowledge graphs. Some enterprises, particularly financial institutions, are obligated to perform KYC investigations prior to onboarding the clients. This process is aimed at reducing the likelihood of sanction bypasses, money laundering, fraud and other forms of financial crime. Conventional knowledge graphs are unable to give financial institutions the ability to conduct KYC investigations because they cannot account for or illuminate the various complex, uncertain, and possibly contradictory relationships that a proper KYC investigation needs to cover. It thus because nearly impossible to track any underlying crimes or enforce sanctions.

As an example, client relationship and KYC checks may different based on geography and regulatory jurisdiction. In some geographies having a specific relationship with a single line of business in the financial firm does not automatically qualify the individual or legal entity as a client, in others it does. Similarly, employee compliance for financial crime may require complex definitions when service providers, employees, contractors, sub-contractors and others are factored into the complex employment relationship functions. Hence, the company's compliance policies on these individuals become complex and interdependent relationships. This becomes for prominent for financial crime detection applications for compliance such as bid rigging, price fixing, insider trading detection.

It is noted that steps for generating and updating the knowledge graphs can proceed in different orders depending on the application. As an example, while in many cases it the knowledge graph can be generated starting with the entities and relationships between the entities, it is possible to generate a knowledge graph starting with function descriptions first, and populating the knowledge graph with entities and relationships subsequently. Updating can proceed in different orders and directions as well.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the disclosure has been described with reference to exemplary embodiments, it will be understood by those skilled in the art that various changes may be made and equivalents may be substituted for elements thereof without departing from the scope of the disclosed invention. In addition, many modifications will be appreciated by those skilled in the art to adapt a particular instrument, situation or material to the teachings of the disclosure without departing from the essential scope thereof. Therefore, it is intended that the invention not be limited to the particular embodiment disclosed as the best mode contemplated for carrying out this invention, but that the invention includes all embodiments falling within the scope of the appended claims.

What is claimed is:

1. A computer-implemented method of providing a multi-dimensional knowledge graph that includes entities and relationships between entities, the method, executed by a processing unit of a computing system, comprising:
generating an initial entity component of the knowledge graph using underlying stored or streamed data, the entity component including a plurality of entity nodes and one or more relationship edges comprising connections between the entities;
storing the entity component in a computer memory;
associating at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds without human intervention until all conditions, parameters and other factors that determine a state of the particular one of the particular one or more relationships edges included in the graph; and
storing all associated requirements included in the knowledge graph for the particular one of the one or more relationship edges in the computer memory.

2. The method of claim 1, further comprising automatically updating a status of the entities, relationships and one or more function based on underlying data.

3. The method of claim 1, further comprising displaying the knowledge graph such that the different dimensions, representing different levels of recursion, are presented as spatially separated to thereby provide a visual representation of the levels of recursion.

4. The method of claim 1, wherein the function includes one or more of: a) logical and rule-based relationships; b) multivariate functions; c) temporal functions; d) vector functions; e) stochastic functions; f) deterministic functions; g) static functions and h) hybrid functions.

5. The method of claim 4, wherein the logical and rule-base relationships include one or more of: a) OR; b) AND; c) XOR; d) XNOR; e) NAND; f) NOR; g) negation (NOT); and h) if/then conditional statements including if then else and if then only.

6. The method of claim 1, wherein one the function is learned using a machine learning system.

7. The method of claim 6, wherein the machine learning system includes a neural-network based architecture.

8. The method of claim 7, wherein the neural-network based architecture includes one or more sub-components including one or more of a convolutional neural network, a multi-layer perceptron, a recurrent neural network, and a Boltzmann network.

9. The method of claim 8, further comprising:
inputting historical data, entity-related information, previously generated knowledge graphs into the machine learning system;
inputting a new knowledge graph invoking the machine learning system to approximate a relationship function; and
approximating the function, using the machine learning system, by a process of matching information in the new knowledge graph with information provided in the historical data, entity-related information, previously generated knowledge graphs.

10. The method of claim 1, wherein the plurality of entity nodes include financial transactions, events, actions or entities, and wherein relationships between the financial transactions relate to compliance of the financial transactions, event, actions or participants with regulations.

11. The method of claim 10, wherein at least the first requirement from the one or more of the relationships defines a function that determines whether the financial transactions, events, actions or entities are in compliance with regulations.

12. The method of claim 10, further comprising:
determining a status of a compliance-related relationship between the entities of the knowledge graph by calculating the function of the function associated with the relationship edge;
detecting whether at least one of the financial transactions, event, action or entity is in compliance based on the determined status of the relationships of the knowledge graph.

13. The method of claim 12, wherein the function is calculated based on conditions including one or more of: a time or date, a geographical location, and a citizenship of one or more of the financial transactions, events, actions or entities.

14. A computer-implemented method of determining a status of a relationship in a multi-dimensional knowledge graph that includes entities and relationships between entities, the method, executed by a processing unit of a computing system, comprising:
generating an initial entity component of the knowledge graph using underlying stored or streamed data, the entity component including a plurality of entity nodes and one or more relationship edges comprising connections between the entities;
storing the entity component in a computer memory;
associating at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds without human intervention until all conditions, parameters and other factors that determine a state of the particular one of the particular one or more relationships edges included in the graph;
storing all associated requirements included in the knowledge graph for the particular one of the one or more relationship edges in the computer memory;
receiving a query to determine the status of the particular relationship in the knowledge graph;
locating the particular relationship in the knowledge graph; and
automatically determining the status of the relationship by ascertaining all of the requirements associated with the relationship and calculating all of the functions, without human intervention.

15. The method of claim 14, wherein the function includes one or more of: a) logical and rule-based relationships; b) multivariate functions; c) temporal functions; d) vector functions and e) stochastic functions; f) deterministic functions; g) static functions and h) hybrid functions.

16. The method of claim 15, wherein the logical and rule-base relationships include one or more of: a) OR; b) AND; c) XOR; d) XNOR; e) NAND; f) NOR; g) negation (NOT); and h) if/then conditional statements including if then else and if then only.

17. A computer-implemented method of determining whether a financial transaction, event, action or entity is in compliance with a regulation, performed using a multi-dimensional knowledge graph that includes entities and relationships between entities, the method, executed by a processing unit of a computing system, comprising:
generating an initial entity component of the knowledge graph using underlying stored or streamed data, the entity component including a plurality of entity nodes and one or more relationship edges comprising connections between the entities wherein the plurality of entity nodes include financial transactions, events, actions or participants, and wherein relationships between the financial transactions relate to compliance of the financial transactions, event, actions or entities with regulations;
storing the entity component in a computer memory;
associating at least a first requirement with a particular one of the one or more of the relationship edges, the at least one requirement defining an iterative or recursive functional description (“function”) of the relationship edge to which it is associated, wherein the function defines a dependency of the relationship upon conditions, parameters and other factors and wherein each iteration or recursion of the requirement defines a dimension of the knowledge graph and such iteration or recursion proceeds without human intervention until all conditions, parameters and other factors that determine a state of the particular one of the particular one or more relationships edges included in the graph;
storing all associated requirements included in the knowledge graph for the particular one of the one or more relationship edges in the computer memory;
querying the knowledge graph to ascertain the compliance status of a relationship present in the knowledge graph; and
automatically determining the status of the relationship by ascertaining all of the connections and associated functions connected to the relationship and calculating all of the recursively defined functions.

18. The method of claim 17, wherein the function is calculated based on conditions including one or more of: time or date, geographical location, and citizenship of one or more of the financial transactions, events, actions or entities.
